(19) United States
(12) Patent Application Publication
(10) Pub. No.: US 2009/0058040 A1
(43) Pub. Date: Mar. 5, 2009

(54) Front Wheel Suspension for Motorcycles

(75) Inventors: Gerd WOESLE, Muenchen (DE); Mike Hubertz, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/268,246

(22) Filed: Nov. 10, 2008

Related U.S. Application Data
(63) Continuation of application No. PCT/EP2007/003484, filed on Apr. 20, 2007.

(30) Foreign Application Priority Data
May 11, 2006 (DE) 10 2006 021 912.0

(51) Int. Cl. B62K 25/24

(52) U.S. Cl. 280/276

(57) ABSTRACT

A front-wheel suspension for motorcycles, having a fork-type wheel carrier with a left fork arm and a right fork arm, a lower connection element mutually connecting the two fork arms and an upper connection element mutually connecting the two fork arms. The wheel carrier is swivelably linked to other components of the motorcycle by a lower and an upper longitudinal control link. Forward ends of the longitudinal control links are connected with the wheel carrier by way of an upper and lower swivel bearing respectively whose swivel axes extend essentially transversely with respect to the longitudinal direction of the motorcycle.

### CROSS-REFERENCE TO RELATED APPLICATIONS

This application is a continuation of PCT International Application No. PCT/EP2007/003484, filed on Apr. 20, 2007, which claims priority under 35 U.S.C. § 119 to European Application No. 10 2006 021 912.0, filed May 11, 2006, the entire disclosures of which are expressly incorporated by reference herein.

### BACKGROUND AND SUMMARY OF THE INVENTION

The present invention relates to a front-wheel suspension for motorcycles.

The “K1200 S” motorcycle by BMW has a front-wheel suspension that is known as a “Duolever” front wheel suspension. Kinematically, the Duolever front wheel suspension is a four-bar mechanism which is formed by two longitudinal control links arranged above one another and each swivellably disposed on the frame or on an engine power section. Forward ends of the longitudinal control links are each connected by way of a ball joint with a fork-type “wheel carrier” which, in the case of the K1200 S, is produced in one piece from shell cast aluminum. The suspension and damping is taken over by a spring strut which is linked to the lower of the two longitudinal control links and is supported against the frame. A trapezoidal shear joint disposed at the “control head” and wheel carrier is coupled with the control link and transmits the steering motions controlled in by way of the control link to the wheel carrier.

During the transition from static friction to kinetic friction, that is, during the compression of the wheel carrier as well as during the steering out of a “rest position”, ball joints have certain, although minor “breakaway torques”. Thus, in order to arrive in the kinetic friction state, a slightly greater static friction torque first has to be overcome.

It is an object of the invention to create an improved “Duolever front-wheel suspension” where “breakaway torques” do not occur.

The starting point of the invention is a “Duolever” front-wheel suspension” for motorcycles having a fork-type wheel carrier which has a left “fork arm” and a right “fork arm” as well as a lower connection element mutually connecting the two fork arms and an upper connection element mutually connecting the two fork arms. The term “wheel carrier” is to be interpreted very broadly and comprises one-piece wheel carriers, which may be produced, for example, in the form of a casting, as well as telescopic forks having a lower and an upper fork bridge. The wheel carrier is suspended by means of a lower and an upper longitudinal control link on other “components” of the motorcycle. Rearward ends of the longitudinal control links can be swivellably linked, for example, to a frame or to an engine power section of the motorcycle.

The core of the invention consists of the fact that, in contrast to the Duolever front-wheel suspensions known from the state of the art, forward ends of the longitudinal control links are coupled with the wheel carrier not by way of ball joints but by way of swivel bearings. The forward end of the upper longitudinal control link and the forward end of the lower longitudinal control link are each connected in an articulated manner with the wheel carrier by way of a swivel bearing, whose swiveling axis extends essentially transversely to a longitudinal direction of the motorcycle. These swivel bearings permit suspension movements of the wheel carrier with respect to the frame of the motorcycle.

The two swivel bearings are preferably constructed as roller bearings. By means of roller bearings, “breakaway torques”, as those that may occur in the case of ball joints, are almost completely avoided. Preferably, the forward ends of the longitudinal control links are connected with the wheel carrier exclusively by way of roller bearings.

For ensuring the steerability of the wheel carrier, a further degree of swiveling freedom is required. For this purpose, a tube may be provided which extends between the upper and the lower connection element of the wheel carrier, the upper end of the tube being connected with the upper connection element by way of an upper steering bearing, and the lower end of the tube being connected with the lower connection element by way of a lower steering bearing. The axes of rotation of the two steering bearings are coaxial and extend in a direction that is at least approximately parallel to a longitudinal direction of the fork arms.

Preferably, the two steering bearings are also formed by roller bearings, so that “breakaway torques” are also essentially avoided when steering the wheel carrier.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an oblique view of an embodiment of a front wheel suspension according to the present invention.

### DETAILED DESCRIPTION

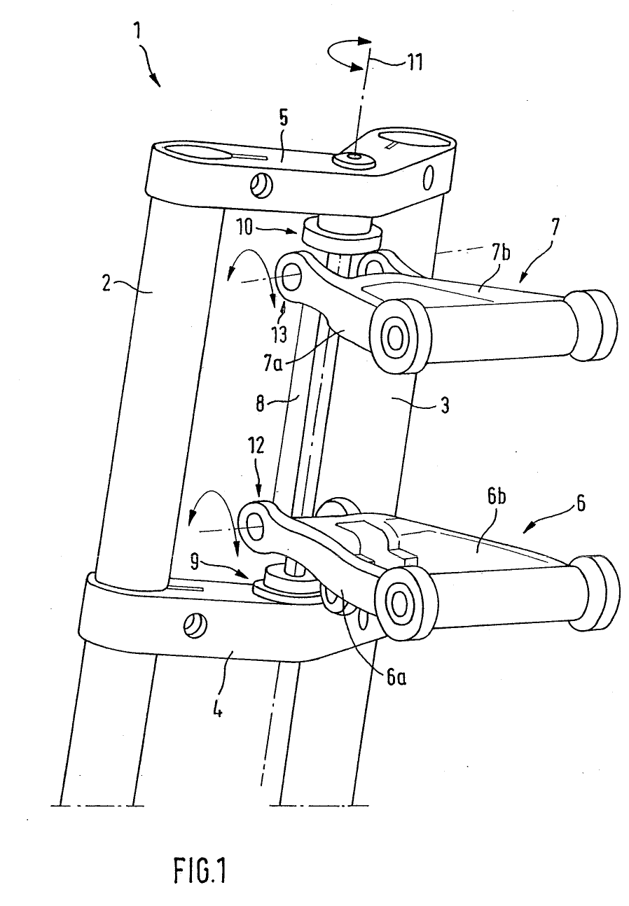

FIG. 1 illustrates a “Duolever front-wheel suspension” for motorcycles. The front-wheel suspension has a fork-type wheel carrier 1 which is formed by a left fork arm 2, a right fork arm 3 as well as a lower fork bridge 4 and an upper fork bridge 5. The two fork bridges 4, 5 mutually connect the two fork arms 2, 3. The fork arms 2, 3 may be fork tubes of a telescopic fork.

As an alternative to the embodiment illustrated here, the wheel carrier may also be constructed as a one-piece wheel carrier, for example, in the form of a casting.

By means of a lower longitudinal control link 6 and an upper longitudinal control link 7, the wheel carrier 1 is disposed on “other components” of a motorcycle not shown here in detail, such as the motorcycle frame and/or an engine power section of the motorcycle. Each of the two longitudinal control links 6, 7 has a left longitudinal control link arm 6a and 7a and a right longitudinal control link arm 6b and 7b respectively.

A control tube 8 extends between the lower fork bridge 4 and the upper fork bridge 5. A lower end of the control tube 8 is connected with the lower fork bridge by way of a roller bearing 9. Correspondingly, an upper end of the control tube 8 is connected with the upper fork bridge 5 by way of a roller bearing 10. The roller bearings 9, 10 are used as steering bearings. The two roller bearings 9, 10 are arranged coaxially, their axis of rotation 11 forming the “steering axis” about which the wheel carrier 1 can be steered.

Forward ends of the longitudinal control link arms 6a, 6b and 7a, 7b respectively are each connected in an articulated manner with the control tube 8 by way of an upper and a lower swivel bearing 12, 13 respectively. The swivel bearings may also be constructed as roller bearings. The swivel bearings 12, 13 permit “suspension movements” of the wheel carrier with respect to the frame of the motorcycle. As a result of the roller bearings 9, 10 or the swivel bearings 12, 13 constructed as roller bearings, “breakaway torques”, like those that may occur in the case of a conventional Duolever front-wheel suspension with ball joints during the compression and rebounding respectively of the front wheel or during the steering of the front wheel, are almost completely avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A front wheel suspension for motorcycles, comprising:
a fork-type wheel carrier having a left fork arm and a right fork arm, a lower connection element mutually connecting the two fork arms and an upper connection element mutually connecting the two fork arms;
a lower longitudinal control link swivelably connected to the motorcycle at a rearward end of the lower link; and
an upper longitudinal control link swivelably connected to the motorcycle at a rearward end of the upper link,
wherein
the wheel carrier is swivelably linked to the motorcycle by the lower longitudinal control link and an upper longitudinal control link, a forward end of the lower longitudinal control link being connected with the wheel carrier by an lower swivel bearing and a forward end of the upper longitudinal control link being connected with the wheel carrier by an upper lower swivel bearing, and
swivel axes of the lower swivel bearing and the upper swivel bearing extend essentially transversely with respect to a longitudinal direction of the motorcycle.

2. The front wheel suspension according to claim 1, wherein
the upper swivel bearing and the lower swivel bearing are roller bearings.

3. The front wheel suspension according to claim 2, wherein
the forward ends of the longitudinal control links are connected in an articulated manner with the wheel carrier by roller bearings.

4. The front wheel suspension according to claim 3, wherein
the wheel carrier has an essentially vertical member extending between the upper and the lower connection element, the upper end of the vertical member being connected with the upper connection element by an upper steering bearing and the lower end of the vertical member being connected with the lower connection element by a lower steering bearing, and
axes of rotation of the upper and lower steering bearings being coaxial and extending in a direction which is approximately parallel to a longitudinal direction of the fork arms.

5. The front wheel suspension according to claim 4, wherein
the upper and lower steering bearings are roller bearings.

6. The front wheel suspension according to claim 5, wherein
the forward ends of the longitudinal control links are connected with the vertical member by the two swivel bearings.

7. The front wheel suspension according to claim 6, wherein
the fork arms are fork tubes.

8. The front wheel suspension according to claim 7, wherein
the connection elements are fork bridge elements which are connected with the fork tubes.

9. The front wheel suspension according to claim 6, wherein
the fork arms and the connection elements are elements of a one-piece wheel carrier.

10. The front wheel suspension according to claim 9, wherein
the wheel carrier is a casting.

11. The front wheel suspension according to claim 1, wherein the rearward ends of the longitudinal control links are swivelably connected with at least one of a frame and an engine power unit of the motorcycle.
